(19) United States
(12) Patent Application Publication
(10) Pub. No.: US 2025/0130822 A1
(43) Pub. Date: Apr. 24, 2025

(54) SYSTEMS AND METHODS FOR A PERSONALIZED USER INTERFACE USING GENERATIVE AI

(71) Applicant: Yahoo Assets LLC, New York, NY (US)

(72) Inventors: Ariel RAVIV, Haifa (IL); Alexander ZLOTNIK, Tel-Aviv (IL)

(21) Appl. No.: 18/489,163

(22) Filed: Oct. 18, 2023

(51) Int. Cl. G06F 9/451; G06Q 40/04

(52) U.S. Cl. CPC G06F 9/451; G06Q 40/04

(57) ABSTRACT

Various embodiments of this disclosure relate generally to generating a customized output based on account data of a user. The method comprises receiving, by one or more processors, user data from one or more databases, wherein the user data includes user browser history and user account data, creating a user record based on the user account data, wherein the user record includes one or more stocks, determining a stock subset of the one or more stocks, retrieving one or more relevant segments from a vector database, wherein the one or more relevant segments correspond to one or more relevant events that are relevant to the stock subset, generating a personalized output script based on the one or more relevant segments, creating an output based on the personalized output script, and displaying the output on one or more user interfaces of a user device.

### TECHNICAL FIELD

Various embodiments of this disclosure relate generally to systems and methods for using a machine-learning model to generate a personalized user interface, and, more specifically, for generating a customized output (e.g., video, a text-based output, or an audio output) based on user account data.

### BACKGROUND

Users who wish to make informed decisions regarding their financial portfolios typically visit multiple websites and/or financial aggregators for financial insights. However, there are vast amounts of websites and financial aggregators that provide financial information, and it may be difficult for users to stay up-to-date on the latest news and events. Additionally, financial concepts may be complex, where it may be difficult for users to understand the content available online. Conventional methods for reviewing financial content include sources displaying content, such as plain language articles and charts, for users to analyze to determine which, if any, changes the users should make to their portfolios. However, such conventional methods may be tedious and complicated, as the displayed content may be extensive, including irrelevant and relevant content. Additionally, the displayed content may include long text and figures, where users may experience information overload when struggling to review all of the content. As a result, improvements for providing financial content to users when making financial decisions are desired, so as to improve efficiency and the overall user experience.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, embodiments are disclosed for generating a customized output (e.g., a video, a text-based output, or an audio output) based on user account data.

In one aspect, an exemplary embodiment of a method for generating a customized output based on account data of a user is disclosed. The method may include receiving, by one or more processors, user data from one or more databases, wherein the user data includes user browser history and user account data. The method may further include creating, by the one or more processors, a user record based on the user account data, wherein the user record includes one or more stocks. The method may further include determining, by the one or more processors, a stock subset of the one or more stocks. The method may further include retrieving, by the one or more processors, one or more relevant segments from a vector database, wherein the one or more relevant segments correspond to one or more relevant events that are relevant to the stock subset. The method may further include generating, by the one or more processors, a personalized output script based on the one or more relevant segments. The method may further include creating, by the one or more processors, a output based on the personalized output script, the output including one or more graphic visuals corresponding to the personalized output script. The method may further include displaying, by the one or more processors, the output on one or more user interfaces of a user device.

In one aspect, a computer system for generating a customized output based on account data of a user is disclosed. The computer system may comprise a memory having processor-readable instructions stored therein and one or more processors configured to access the memory and execute the processor-readable instructions, which when executed by the one or more processors configures the one or more processors to perform a plurality of functions. The functions may comprise receiving user data from one or more databases, wherein the user data includes user browser history and user account data. The functions may further comprise creating a user record based on the user account data, wherein the user record includes one or more stocks. The functions may further comprise determining a stock subset of the one or more stocks. The functions may further comprise retrieving one or more relevant segments from a vector database, wherein the one or more relevant segments correspond to one or more relevant events that are relevant to the stock subset. The functions may further comprise generating a personalized output script based on the one or more relevant segments. The functions may further comprise creating a output based on the personalized output script, the output including one or more graphic visuals corresponding to the personalized output script. The functions may further comprise displaying the output on one or more user interfaces of a user device.

In one aspect, a non-transitory computer-readable medium containing instructions for generating a customized output based on account data of a user is disclosed. The instructions may comprise receiving user data from one or more databases, wherein the user data includes user browser history and user account data. The instructions may further comprise creating a user record based on the user account data, wherein the user record includes one or more stocks. The instructions may further comprise determining a stock subset of the one or more stocks. The instructions may further comprise retrieving one or more relevant segments from a vector database, wherein the one or more relevant segments correspond to one or more relevant events that are relevant to the stock subset. The instructions may further comprise generating a personalized output script based on the one or more relevant segments. The instructions may further comprise creating a output based on the personalized output script, the output including one or more graphic visuals corresponding to the personalized output script. The instructions may further comprise displaying the output on one or more user interfaces of a user device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary networked computing environment that may be utilized with techniques presented herein, according to one or more embodiments.

FIG. 2 depicts a flowchart of an exemplary method for generating a customized output based on account data of a user, according to one or more embodiments.

FIG. 3 depicts an example of a computing device that may execute the techniques described herein, according to one or more embodiments.

### DETAILED DESCRIPTION OF EMBODIMENTS

According to certain aspects of the disclosure, methods and systems for generating a customized output (e.g., a video, a text-based output, or an audio output) based on user account data are disclosed.

Users who wish to make informed decisions regarding their financial portfolios typically visit multiple websites and/or financial aggregators for financial insights. However, there are vast amounts of websites and financial aggregators that provide financial information, and it may be difficult for users to stay up-to-date on the latest news and events. Additionally, financial concepts may be complex, where it may be difficult for users to understand the content available online. Conventional methods for reviewing financial content include sources displaying content, such as plain language articles and charts, for users to analyze to determine which, if any, changes the users should make to their portfolios. However, such conventional methods may be tedious and complicated, as the displayed content may be extensive, including irrelevant and relevant content. Additionally, the displayed content may include long text and figures, where users may experience information overload when struggling to review all of the content. As a result, improvements for providing financial content to users when making financial decisions are desired, so as to improve efficiency and the overall user experience.

One or more generative Artificial Intelligence (“AI”) models may create personalized financial recaps that may be tailored to a user's specific interests and needs. The generative AI model may have been previously trained to create personalized financial recaps based on financial data and/or user preferences. The generative Al model may create a short video that describes the financial events that are the most relevant to the user's stock portfolio. Natural language processing (“NLP”) and/or video/image processing may be used to identify relevant financial news and events from various websites and social media. The video may include information about the user's stock holdings, as well as news and events that may impact the value of the stocks. The video may also include recommendations for the user, such as whether to buy, sell, or hold their stocks.

Such systems and methods include several advantages. First, the systems and methods may increase the accuracy of the content viewed by the user. For-example, generative AI models may be trained on large datasets of financial data, which may allow the models to identify patterns and trends that would be difficult for humans to spot. This may result in more accurate financial recaps. Second, the systems and methods may reduce information overload and reduce information complexity by personalizing the displayed content. For example, generative AI models may tailor the displayed content according to the user's interests and needs. This may result in the user receiving a financial recap that may be helpful to the user. Additionally, or alternatively, generative Al models may determine a user's literacy level and then provide a financial recap based on the literacy level. Third, the systems and methods may increase user engagement by providing the users with interactive and engaging financial recaps. For example, the generative Al models may create interactive and engaging financial recaps, which may help users to stay engaged with their investments and make better financial decisions.

As will be discussed in more detail below, in various embodiments, systems and methods are described for generating a customized output (e.g., a video, a text-based output, or an audio output) based on account data of a user. The systems and methods may include receiving, by one or more processors, user data from one or more databases, wherein the user data includes user browser history and user account data. The systems and methods may include creating, by the one or more processors, a user record based on the user account data, wherein the user record includes one or more stocks. The systems and methods may include determining, by the one or more processors, a stock subset of the one or more stocks. The systems and methods may include retrieving, by the one or more processors, one or more relevant segments from a vector database, wherein the one or more relevant segments correspond to one or more relevant events that are relevant to the stock subset. The systems and methods may include generating, by the one or more processors, a personalized output script based on the one or more relevant segments. The systems and methods may include creating, by the one or more processors, an output based on the personalized output script, the output including one or more graphic visuals corresponding to the personalized output script. The systems and methods may include displaying, by the one or more processors, the output on one or more user interfaces of a user device.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In the detailed description herein, references to “embodiment,” “an embodiment,” “one non-limiting embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In general, terminology can be understood at least in part from usage in context. For example, terms, such as “and”, “or”, or “and/or,” as used herein can include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and can, instead, allow for existence of additional factors not necessarily expressly described, again, depending at least in part on context.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.” As used herein, the singular forms “a,” “an,” and “the” include plural reference unless the context dictates otherwise. Relative terms such as “about,” “substantially,” and “approximately” refer to being nearly the same as a referenced number or value, and should be understood to encompass a variation of ±5% of a specified amount or value.

As used herein, a “model” or “machine-learning model” generally

encompasses instructions, data, and/or a model configured to receive input, and apply one or more of a weight, bias, classification, or analysis on the input to generate an output (e.g., a video, a text-based output, or an audio output). The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

Certain non-limiting embodiments are described below with reference to block diagrams and operational illustrations of methods, processes, devices, and apparatus. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

### Exemplary Environment

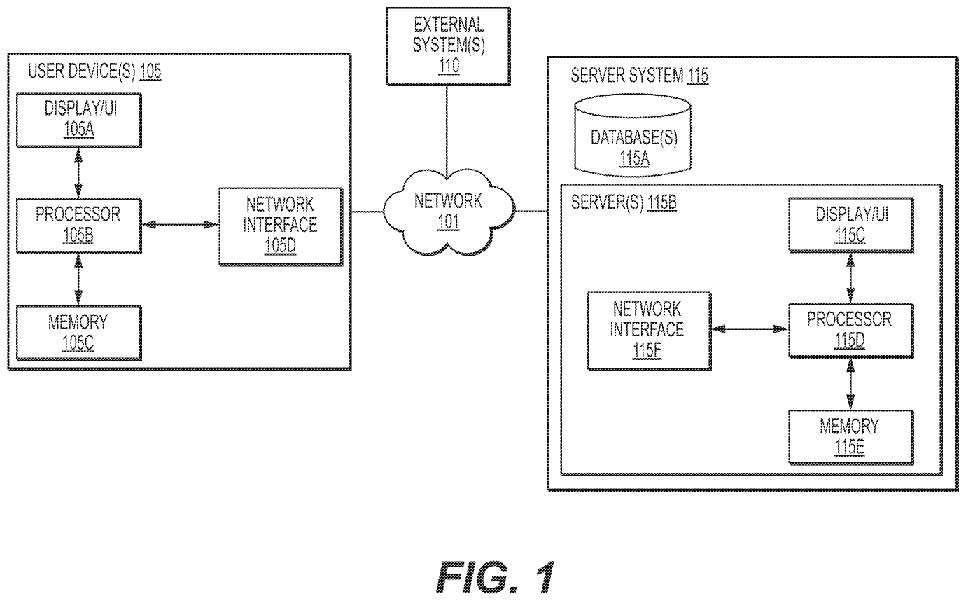

FIG. 1 depicts an exemplary environment 100 that may be utilized with techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more user device(s) 105 may be associated with a user, e.g., a user associated with one or more of generating, training, or tuning a machine-learning model for generating a customized output (e.g., a video, a text-based output, or an audio output) based on user account data.

In some embodiments, the components of the environment 100 are associated with a common entity. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, and/or use a machine-learning model to generate a customized output based on user account data, among other activities.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115 in performing various output customization tasks. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may generate, store, train, or use a machine-learning model, configured to generate a customized output based on user account data. The server system 115 may include a machine-learning model and/or instructions associated with the machine-learning model, e.g., instructions for generating a machine-learning model, training the machine-learning model, using the machine-learning model, etc. The server system 115 may include instructions for customizing outputs based on user account data, e.g., based on the output of the machine-learning model, and/or operating the display 115C to output an action, e.g., as adjusted based on the machine-learning model. The server system 115 may include training data.

In some embodiments, a system or device other than the server system 115 is used to generate and/or train the machine-learning model. For example, such a system may include instructions for generating the machine-learning model, the training data and ground truth, and/or instructions for training the machine-learning model. A resulting trained machine-learning model may then be provided to the server system 115.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between user literacy, audio output, and assets (e.g., stocks), such that the trained machine-learning model is configured to determine a user's literacy level and provide audio output based on the learned associations.

In various embodiments, the variables of a machine-learning model may be interrelated in any suitable arrangement in order to generate the output. For example, the machine-learning model may include one or more convolutional neural network (“CNN”) configured to identify user preferences (e.g., a user literacy level), and may include further architecture, e.g., a connected layer, neural network, etc., configured to determine a relationship between a personalized output and the user preferences.

Further aspects of the machine-learning model and/or how it may be

utilized to generate a customized output based on user account data in further detail in the method below. In the following method, various acts may be described as performed or executed by a component from FIG. 1, such as the server system 115, the user device 105, or components thereof. However, it should be understood that in various embodiments, various components of the environment 100 discussed below may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

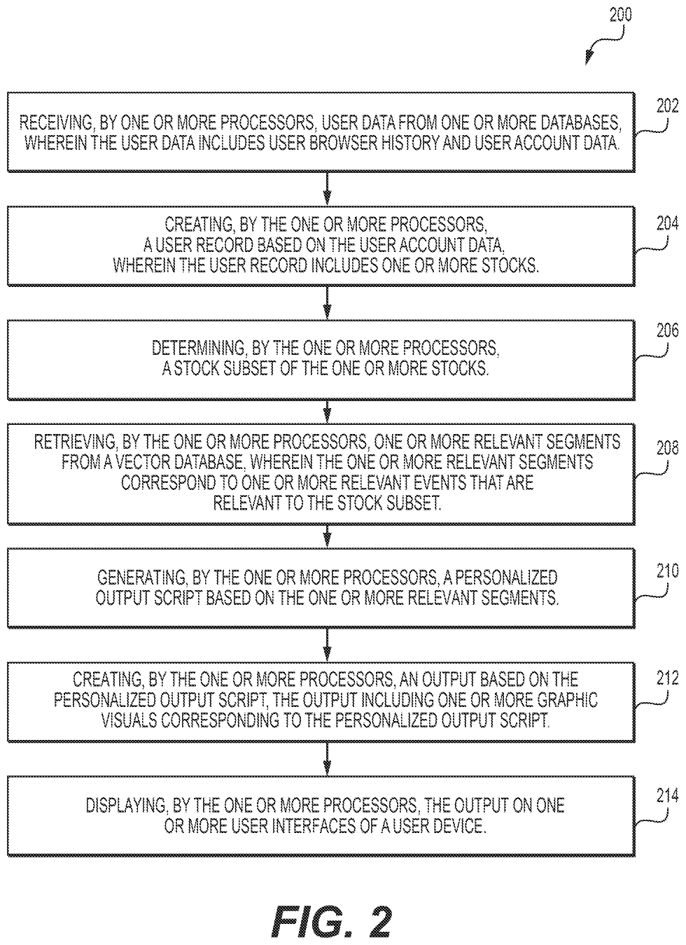

In general, any process or operation discussed in this disclosure that is understood to be computer-implementable, such as the process illustrated in FIG. 2, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples below, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

### Exemplary Method for Generating a Customized Output

FIG. 2 depicts a flowchart of an exemplary method 200 for generating a customized output (e.g., a video, an audio clip, an article, etc.) based on account data of a user, according to one or more embodiments. Method 200 may be performed by one or more processors of a server that is in communication with one or more user devices and other external system(s) via a network. However, it should be noted that method 200 may be performed by any one or more of the server, one or more user devices, or other external systems.

The method may include receiving, by one or more processors, user data from one or more databases, wherein the user data includes user browser history and the account data (Step 202). In some embodiments, the user data may include one or more user preferences. Additionally, or alternatively, for example, the user data may include feedback from the user with respect to a previous video displayed on a user device. The user preferences may include a user literacy level. The user literacy level may indicate how well the user may read and/or interpret data. The user literacy level may be determined based on the user's browser history. For example, the system may analyze the user's search history, as well as the type of articles and web pages visited by the user, to determine a literacy level of the user. The user data may also include the user browser history. The user browser history may include searches performed by the user, websites visited by the user, industry sectors the user is looking to invest, stocks and/or investors that the user follows (e.g., via social media), and the like. The user account data may correspond to one or more financial accounts belonging to the user. The user account data may include user information (e.g., user name, user birthdate, user address), assets (e.g., stocks, bonds), asset values, whether the assets are currently held, asset purchase prices, asset sell prices, and the like. Additionally, one or more databases may store the user account data, where the one or more databases may receive updated account data periodically (e.g., every hour, every day, every month). The system may receive some or all of the user account data from the databases. In some embodiments, the system may retrieve some of all of the user account data from the databases. The financial accounts may include brokerage accounts, stock accounts, bank accounts, and/or any other financial account. The financial accounts may belong to the same platform as the system. In some embodiments, at least one of the financial accounts belongs to one or more external systems. For example, one of the financial accounts may include a stock account that is run by a financial institution.

The method may further include creating, by the one or more processors, a user record based on the account data, wherein the user record includes one or more stocks (Step 204). The user record may include some or all of the user preferences, such as the user literacy level. The system may analyze some or all of the user account data to determine which account data should be included in the user record. For example, the user record may include user details, asset details, and the like. The user details may include a user name, a user birthdate, a user address, and the like. The asset details may include asset identifiers (e.g., a stock identifier), asset values (e.g., the value of a stock), asset quantities (e.g., how many stock units the user owns), asset acquisition details (e.g., when the stock was purchased and/or sold), and the like. The assets may include at least one stock, at least one bond, and/or any other type of investment. The one or more stocks may include at least one of: at least one stock owned by the user, at least one stock previously owned by the user, at least one stock followed by the user (e.g., followed by the user via social media), at least one stock owned by one or more other users (e.g., investors) that the user follows (e.g., a user followed via social media), at least one stock watched by the one or more other users (e.g., investors) that the user follows (e.g., a user followed via social media), at least one stock owned by one or more other users with a similar portfolio, or at least one stock watched by the one or more other users with the similar portfolio. The similar portfolio may be calculated using a generic collaborative-filtering approach.

In some embodiments, the method may further include ranking, by the one or more processors, the one or more stocks of the user record based on a priority, wherein the priority may be based on one or more heuristic rules. The ranking may be performed by a machine-learning model. For example, a machine-learning model may analyze and rank the stocks included in the user record based on a priority of the stocks. The priority may be based on how long the user owns the asset, how much of the asset makes up the user's portfolio, predicting which assets are/may become important based on current events, and the like. Additionally, or alternatively, the priority may be based on one or more heuristic rules. For example, the one or more heuristic rules may be based on a weight of the asset volume against the time the asset was held by the user.

The method may further include determining, by the one or more processors, a stock subset of the one or more stocks (Step 206). The stock subset may include some or all of the stocks included in the user record. The stock subset may include a certain number of stocks that have the highest ranking of all the stocks. The system may have a default number of stocks that should be included in the subset. For example, the stock subset may include five stocks with the highest ranking.

The method may further include retrieving, by the one or more processors, one or more relevant segments from a vector database, wherein the one or more relevant segments correspond to one or more relevant events that are relevant to the stock subset (Step 208). The vector database may store the relevant segments, where each of the relevant segments may include text segments that summarize one or more events. The segments may also include graphics, such as charts, diagrams, and the like. The events may be gathered from a variety of sources, such as news websites, financial newswires, and social media. The events may include news and financial events that may be relevant to the user's financial portfolio. Specifically, the events may relate to at least one stock in the stock subset. For example, a relevant event may include a web page that describes a news event, where the news event may be related to a particular stock.

In some embodiments, retrieving the one or more relevant segments from the vector database may include building, by the one or more processors, the vector database. Specifically, building the vector database may include: for one or more time periods, analyzing, by the one or more processors, one or more sources of information, converting, by the one or more processors, data of the one or more sources to one or more short segments using a machine-learning model, storing, by the one or more processors, the one or more short segments in the one or more databases, processing, by the one or more processors, the one or more short segments to determine a corresponding latent vector for each of the one or more short segments, and storing, by the one or more processors, the processed one or more short segments and the corresponding latent vector in the vector database. For each time period (e.g., 10 minutes, an hour, a day), a system may crawl a variety of sources, such as new websites, financial newswires, and/or social media for financial information. The system may store the financial information as one or more segments. The system may then summarize the financial information (e.g., content displayed on the sources (such as articles)) to create short text segments. Additionally, or alternatively, the system may analyze the financial information (e.g., content displayed via one or more sources) and create one or more graphics based on the financial information. For example, the system may create a chart based on content display by one or more sources. In some embodiments, the system may utilize one or more machine-learning models, such as a generative Large Language Model (LLM), to perform the summarizing. The system may then store each of the short text segments in one or more databases. The system may also process the short text segments to determine a corresponding latent vector for each of the segments. The system may then store the short text segments and corresponding latent vectors in one or more vector databases. For example, for effective retrieval, a machine-learning model (e.g., a Large Language Model (LLM)) may process each segment to determine the corresponding latent vector. In some embodiments, images and video may also be processed in a similar fashion.

Retrieving the one or more relevant segments from the vector database may further include querying, by the one or more processors, the vector database for the one or more relevant events and the corresponding one or more relevant segments. Additionally, querying the vector database may include: receiving, by the one or more processors, the stock subset, processing, by the one or more processors, stock information corresponding to each of the one or more stocks in the stock subset to produce one or more vector queries, the stock information including at least one stock ticker, at least one name, or at least one company name, and querying, by the one or more processors, the vector database for information related to each of the one or more vector queries. Upon a user accessing the platform (e.g., logging into an account), the system may retrieve and/or receive the stock subset, where the stock subset may include the top ranked stock. The system may then process information associated with each stock in the stock subset to produce a vector query. Exemplary information may include the stock ticker, the stock name, a company name, a stock value, and the like. In some embodiments, a machine-learning model may process the stock information to produce the vector query. The system may then query the vector database for information related to each stock of the stock subset. For example, the system may query the vector database for at least one related event. In response to the query, the vector database may return at least one related event to the stock, as well as a summary of the event (e.g., a corresponding segment). Upon receiving the at least one related event, the system may filter and rank the retrieve information based on the relevancy and recency of the information. For example, the system may receive three related online articles, where two of the articles were a day old and one of the articles was a week old. The system may filter the events so that the system may filter the events so that only the two articles with the most recent dates remain.

The method may further include generating, by the one or more processors, a personalized output script based on the one or more relevant segments (Step 210). The personalized output script may include a script for at least one of a video, a text-based output, or an audio output. For example, the video may correspond to one or more video clips and the like. The text-based output may correspond to one or more articles, publications, presentations, and the like. The audio output may correspond to one or more audio clips and the like. The script may be created by compiling all of the relevant segments that correspond to the stock subset. Then, based on the relevant segments, a machine-learning model (e.g., generative AI) may produce a script that is based on the content of the relevant segments. The machine-learning model may create a script that summarizes the relevant news and financial events. In some embodiments, the machine-learning model may have been previously trained to generate scripts based on the user's record data, such as the user's literacy level, preferences, stock subset, and the like. The machine-learning model may receive the script that includes the compiled segments, and then modify the script based on the user's record data. For example, the trained machine-learning model may modify the compiled segments based on the user's literacy level. By way of further example, if the user has a low literacy level, the trained machine-learning model may replace one or more words in the script with more easily understood words.

The method may further include creating, by the one or more processors, an output based on the personalized output script, the output including one or more graphic visuals corresponding to the personalized output script (Step 212). The output may include at least one of a video, a text-based output, or an audio output. For example, the video may correspond to one or more video clips and the like. The text-based output may correspond to one or more articles, publications, presentations, and the like. The audio output may correspond to one or more audio clips and the like. In some embodiments, a machine-learning model may create the output by generating one or more graphic visuals corresponding to the personalized output script. For example, the machine-learning model may generate a graphic visual for each script segment that corresponds to a relevant segment. The graphic visual may include a short video clip that includes charts, video graphics, one or more people, and the like. The machine-learning model may then concatenate the graphic visuals for each script segment, resulting in an output (e.g., a video) that includes all of the graphic visuals for all of the script segments. In some embodiments, the machine-learning model may include a subset of the graphic visuals. For example, the method may include analyzing the length (e.g., the length of time) of each of the graphic visuals, and then determining a subset of graphic visuals that should be concatenated to form an output (e.g., a video). Additionally, or alternatively, determining the subset of graphic visuals may include comparing the time length of various graphic visual concatenation combinations to a time threshold, in order to determine the subset of graphic visuals that, when concatenated, meet or fall below the time threshold. For example, three graphic visuals may have a length of 10 seconds, 5 seconds, and 20 seconds, where the time threshold may be 30 seconds. Upon comparing the time lengths of various concatenation combinations to the 30 second time threshold, the system may determine that the graphic visuals with a length of 10 seconds and 20 seconds should be concatenated into an output (e.g., a video). In some embodiments, the machine-learning model may determine the graphic visuals that, when concatenated, meet or fall below the time threshold.

The method may further include displaying, by the one or more processors, the output on one or more user interfaces of a user device (Step 214). The output may include at least one of a video, a text-based output, or an audio output. For example, the video may correspond to one or more video clips and the like. Displaying the video may include displaying all or part of the one or more video clips. The text-based output may correspond to one or more articles, publications, presentations, and the like. Displaying the text-based output may include displaying all or some of the one or more articles, publications, presentations, and the like. The audio output may correspond to one or more audio clips and the like. Displaying the audio output may include playing some or part of the one or more audio clips and/or displaying text corresponding to the one or more audio clips. The one or more user interfaces may correspond to one or more mobile applications. Exemplary mobile applications may include financial mobile application, social media mobile applications, and the like. The user interfaces of the mobile applications may display the output (e.g., a video). In some embodiments, the displaying the output (e.g., a video) may also include displaying a graphical widget for receiving user feedback. The user feedback may indicate whether the output (e.g., video) was too short, too long, contained irrelevant information, contained relevant information, and the like. The user may be able to provide feedback via a thumbs up widget, a thumbs down widget, and/or a comment box. In some embodiments, the machine-learning model may receive and utilize the feedback when providing future output (e.g., videos) to the user.

In some embodiments, the method may further include storing, by the one or more processors, the output in a database record in the one or more databases, wherein the database record includes a reference to the user record. The one or more databases may include a database record, where the database record may include the user record and the output (e.g., a video). Additionally, or alternatively, the database record may include the output and a reference (e.g., a unique identifier) to the user record. In some embodiments, the stored output may be updated and then displayed.

Although FIG. 2 shows example blocks of exemplary method 200, in some implementations, the exemplary method 200 may include additional blocks, fewer blocks, different blocks, or differently arranged blocks than those depicted in FIG. 2. Additionally, or alternatively, two or more of the blocks of the exemplary method 200 may be performed in parallel.

### Exemplary Device

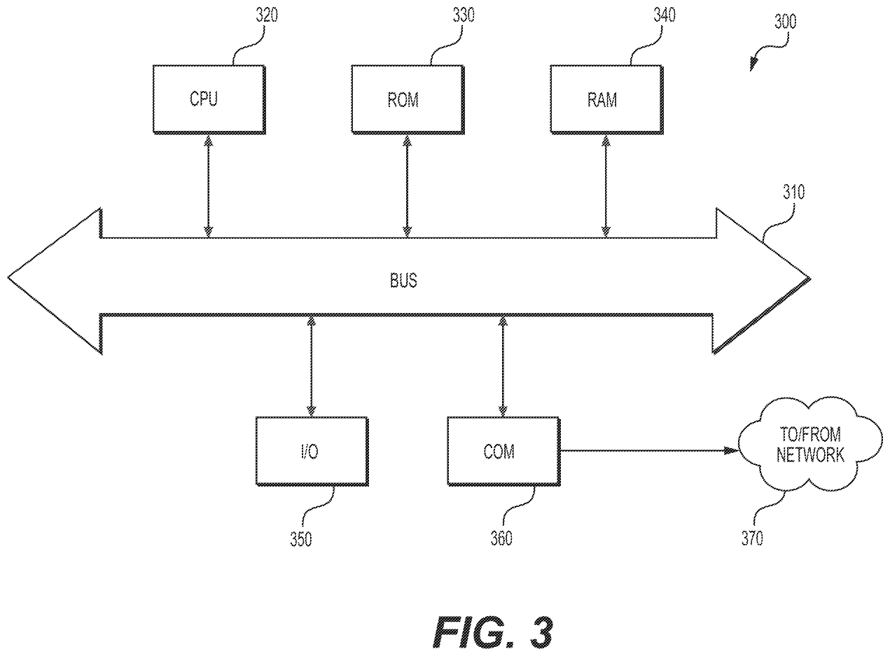

FIG. 3 is a simplified functional block diagram of a computer 300 that may be configured as a device for executing the method of FIG. 2, according to exemplary embodiments of the present disclosure. For example, device 300 may include a central processing unit (CPU) 320. CPU 320 may be any type of processor device including, for example, any type of special purpose or a general-purpose microprocessor device. As will be appreciated by persons skilled in the relevant art, CPU 320 also may be a single processor in a multi-core/multiprocessor system, such system operating alone, or in a cluster of computing devices operating in a cluster or server farm. CPU 320 may be connected to a data communication infrastructure 310, for example, a bus, message queue, network, or multi-core message-passing scheme.

Device 300 also may include a main memory 340, for example, random access memory (RAM), and also may include a secondary memory 330. Secondary memory 330, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 330 may include other similar means for allowing computer programs or other instructions to be loaded into device 300. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 300.

Device 300 also may include a communications interface (“COM”) 360. Communications interface 360 allows software and data to be transferred between device 300 and external devices. Communications interface 360 may include a modem, a network interface (such as an Ethernet card), a communications port, a PCMCIA slot and card, or the like. Software and data transferred via communications interface 360 may be in the form of signals, which may be electronic, electromagnetic, optical, or other signals capable of being received by communications interface 360. These signals may be provided to communications interface 360 via a communications path of device 300, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 300 also may include input and output ports 350 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as those used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the general description and the detailed description are exemplary and explanatory only and are not restrictive of the features, as claimed.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for generating a customized output based on account data of a user, the computer-implemented method comprising:
receiving, by one or more processors, user data from one or more databases, wherein the user data includes user browser history and user account data;
creating, by the one or more processors, a user record based on the user account data, wherein the user record includes one or more stocks;
determining, by the one or more processors, a stock subset of the one or more stocks;
retrieving, by the one or more processors, one or more relevant segments from a vector database, wherein the one or more relevant segments correspond to one or more relevant events that are relevant to the stock subset;
generating, by the one or more processors, a personalized output script based on the one or more relevant segments;
creating, by the one or more processors, an output based on the personalized output script, the output including one or more graphic visuals corresponding to the personalized output script; and
displaying, by the one or more processors, the output on one or more user interfaces of a user device.

2. The computer-implemented method of claim 1, the computer-implemented method further comprising:
storing, by the one or more processors, the output in a database record in the one or more databases, wherein the database record includes a reference to the user record.

3. The computer-implemented method of claim 1, wherein the one or more stocks include at least one of: at least one stock owned by the user, at least one stock previously owned by the user, at least one stock followed by the user, at least one stock owned by one or more other users that the user follows, at least one stock watched by the one or more other users that the user follows, at least one stock owned by one or more other users with a similar portfolio, or at least one stock watched by the one or more other users with the similar portfolio.

4. The computer-implemented method of claim 1, wherein the output includes at least one of: a video, a text-based output, or an audio output.

5. The computer-implemented method of claim 1, the computer-implemented method further comprising:
ranking, by the one or more processors, the one or more stocks of the user record based on a priority, wherein the priority is based on one or more heuristic rules.

6. The computer-implemented method of claim 5, wherein the ranking is performed by a machine-learning model.

7. The computer-implemented method of claim 1, wherein retrieving the one or more relevant segments from the vector database comprises:
building, by the one or more processors, the vector database; and
querying, by the one or more processors, the vector database for the one or more relevant events and the corresponding one or more relevant segments.

8. The computer-implemented method of claim 7, wherein the building the vector database comprises:
for one or more time periods, analyzing, by the one or more processors, one or more sources of information;
converting, by the one or more processors, data of the one or more sources to one or more short segments using a machine-learning model;
storing, by the one or more processors, the one or more short segments in the one or more databases;
processing, by the one or more processors, the one or more short segments to determine a corresponding latent vector for each of the one or more short segments; and
storing, by the one or more processors, the processed one or more short segments and the corresponding latent vector in the vector database.

9. The computer-implemented method of claim 7, wherein querying the vector database comprises:
receiving, by the one or more processors, the stock subset;
processing, by the one or more processors, stock information corresponding to each of the one or more stocks in the stock subset to produce one or more vector queries, the stock information including at least one stock ticker, at least one name, or at least one company name; and
querying, by the one or more processors, the vector database for information related to each of the one or more vector queries.

10. A computer system for generating a customized output based on account data of a user, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
receiving user data from one or more databases, wherein the user data includes user browser history and user account data;
creating a user record based on the user account data, wherein the user record includes one or more stocks;
determining a stock subset of the one or more stocks;
retrieving one or more relevant segments from a vector database, wherein the one or more relevant segments correspond to one or more relevant events that are relevant to the stock subset;
generating a personalized output script based on the one or more relevant segments;
creating an output based on the personalized output script, the output including one or more graphic visuals corresponding to the personalized output script; and
displaying the output on one or more user interfaces of a user device.

11. The computer system of claim 10, wherein the output includes at least one of: a video, a text-based output, or an audio output.

12. The computer system of claim 10, the functions further comprising:
ranking the one or more stocks of the user record based on a priority, wherein the priority is based on one or more heuristic rules.

13. The computer system of claim 10, wherein identifying the one or more relevant events comprises:
building the vector database; and
querying the vector database for the one or more relevant events and the corresponding one or more relevant segments.

14. The computer system of claim 10, wherein the one or more stocks include at least one of: at least one stock owned by the user, at least one stock previously owned by the user, at least one stock followed by the user, at least one stock owned by one or more other users that the user follows, at least one stock watched by the one or more other users that the user follows, at least one stock owned by one or more other users with a similar portfolio, or at least one stock watched by the one or more other users with the similar portfolio.

15. The computer system of claim 10, wherein retrieving the one or more relevant segments from the vector database comprises:
building the vector database; and
querying the vector database for the one or more relevant events and the corresponding one or more relevant segments.

16. A non-transitory computer-readable medium containing instructions for generating a customized output based on account data of a user, the instructions comprising:
receiving user data from one or more databases, wherein the user data includes user browser history and user account data;
creating a user record based on the user account data, wherein the user record includes one or more stocks;
determining a stock subset of the one or more stocks;
retrieving one or more relevant segments from a vector database, wherein the one or more relevant segments correspond to one or more relevant events that are relevant to the stock subset;
generating a personalized output script based on the one or more relevant segments;
creating a output based on the personalized output script, the output including one or more graphic visuals corresponding to the personalized output script; and
displaying the output on one or more user interfaces of a user device.

17. The non-transitory computer-readable medium of claim 16, wherein retrieving the one or more relevant segments from the vector database comprises:
building the vector database; and
querying the vector database for the one or more relevant events and the corresponding one or more relevant segments.

18. The non-transitory computer-readable medium of claim 17, wherein the building the vector database comprises:
for one or more time periods, analyzing one or more sources of information;
converting data of the one or more sources to one or more short segments using a machine-learning model;
storing the one or more short segments in the one or more databases;
processing the one or more short segments to determine a corresponding latent vector for each of the one or more short segments; and
storing the processed one or more short segments and the corresponding latent vector in the vector database.

19. The non-transitory computer-readable medium of claim 17, wherein querying the vector database comprises:
receiving the stock subset;
processing stock information corresponding to each of the one or more stocks in the stock subset to produce one or more vector queries, the stock information including at least one stock ticker, at least one name, or at least one company name; and
querying the vector database for information related to each of the one or more vector queries.

20. The non-transitory computer-readable medium of claim 16, wherein the output includes at least one of: a video, a text-based output, or an audio output.
